(19) United States
(12) Patent Application Publication
(10) Pub. No.: US 2005/0170322 A1
(43) Pub. Date: Aug. 4, 2005

(54) Development of a cost effective, on-site personnel trainer for boiler operations

(76) Inventors: Daniel Patrick Midden, Lexington, KY (US); Donald Peter Midden, Ewing, KY (US)

Correspondence Address: Daniel Patrick Midden, 1122 Gainesway Court, Lexington, KY, 45017, US

(21) Appl. No.: 10/771,006

(22) Filed: Feb. 4, 2004

(51) Int. Cl. G09B 19/00

(52) U.S. Cl. 434/219

(57) ABSTRACT

In many industrial organizations and educational institutions, boilers are used for heating and/or industrial processes. A number of boiler operators and maintenance personnel do not have the training or expertise to properly operate and/or repair a boiler safely and efficiently, especially in small companies and institutions. Many accidents have been attributed to this lack of training. A trainer of this type would allow the small institution to provide the necessary training for operation and maintenance of the boiler. Since the trainer is built and utilized “in house”, the cost of training is minimal to the company/institution.

### BACKGROUND OF THE INVENTION

The idea behind this project started while the researcher was Attending EET 346 Program Logic Control class. During one class meeting, a group crossed the 12 VDC with the 120 VAC destroying one of the PLC's. The researcher wanted to design a trainer to prevent this occurring, and where it did not matter what brand of PLC was used. After doing some research, the researcher found that this could not be accomplished. A few weeks later, the researcher went to Fleming County Hospital to visit the chief engineer. Inside the boiler room, the researcher noticed that the boiler control panel had burn marks on it. The researcher told the chief engineer the researcher could design and build a new panel for him using a PLC. The engineer liked the idea, but the time frame caused problems because the engineer needed all of his boilers running at the same time that the researcher would be trying to install the new panel. The engineer suggested that the researcher could try to design and build a boiler trainer.

For many people they do not know, what is keeping them warm, as far as they are concerned it is ““out of sight, out of mind”” (Brennan 2). This is especially true for upper management and administrators whose job it is to look at the bottom line. In the past twenty years, the ““out of sight, out of mind”” policy has came back to hurt people some serious injuries have happened. The National Board for Boilers and Pressure Vessels (NB) second recommendation for safe boiler room practices is:
Ensure that all personnel who operate or maintain the boiler are properly trained on all equipment, control(s), safety devices, and up-to-date procedures

There are two reasons why training is important. The first reason is better communication between the personnel operating the equipment and the front office. These are two different worlds for all people involved. Front office personnel are watching the bottom line, while boiler operators are trying to provide services and needs that they have been assigned to do without spending money. Spending a few thousands of dollars in training and preventive maintenance now will save money in the end. With people well trained, communication will increase and attitudes between both sides will change, while working to meet the same goal. The second reason for training is safety. Increased understanding of the equipment and process will allow personnel to know the equipment and predict problems. They will then know what to do in case of an emergency.

There are many different methods available for training people. Whatever method chosen should have a balance of technical and practical knowledge. The first step is to decide what strategy to use when holding training sessions. One effective “in house” training method is mentoring. With mentoring, a more experienced person is placed with a person that is new to an organization or wants to learn more about a field of study (Messmer 4). This is very useful in getting new hires up to speed in a short amount of time. The only cost to the organization is time. Another effective training method is hands on training. Personnel use some type of mechanical trainer to simulate the controls of an actual system. With this method, people can become familiar with the problems of the system, as they become more knowledgeable of what to do in case of an emergency. This is a time consuming process but highly effective when problems arise. Other effective training methods are E learning, which is more flexible to people's schedules, along with self-administered training, and standard classroom training. However, these methods cost money and time which the organization does not have and is trying to reduce at all times.

Any personnel in an industry requiring use of equipment should have the appropriate certification. In doing research, it was found that each state has different requirements for training. There are standards for recertification, which states that personnel should receive retraining every two years or when modifications have been made (Bib 1). The National Board for Boilers and Pressure Vessels (NB) and American Society of Mechanical Engineers (ASME) has certification requirements for the installation, maintenance, and manufacturing of boilers. Each boiler manufacturer has their own set of certification requirements, and the owners should use their guidelines in certification requirements. There is no set standard for daily operation of a boiler this invention would help in setting a standard that will saving time and money.

### BRIEF DESCRIPTION OF THE DRAWINGS

To better understand the invention that has been described above the following drawings, flow charts, and input/output chart have been created.

FIG. 1: Professor View of Boiler Trainer Top View

FIG. 2: Professor View of Boiler Trainer Front View

FIG. 3: Professor View of Boiler Trainer Side View

FIG. 4: Student View of Boiler Trainer Top View

FIG. 5: Student View of Boiler Trainer Front View

FIG. 6: Student View of Boiler Trainer Side View

FIG. 7: Program Logic Controller (PLC) Layout Top View

FIG. 8: Program Logic Controller (PLC) Layout Front View

FIG. 9: Program Logic Controller (PLC) Layout Side View

FIG. 10: Wiring Diagram of Lights

FIG. 11: Wiring Diagram of Switches

FIG. 12: Wiring Diagram of Switched

FIG. 13: Flow Chart of Boiler Start

FIG. 14: Flow Chart of Boiler Stop

FIG. 15: Input/Output Chart of Logic Gates

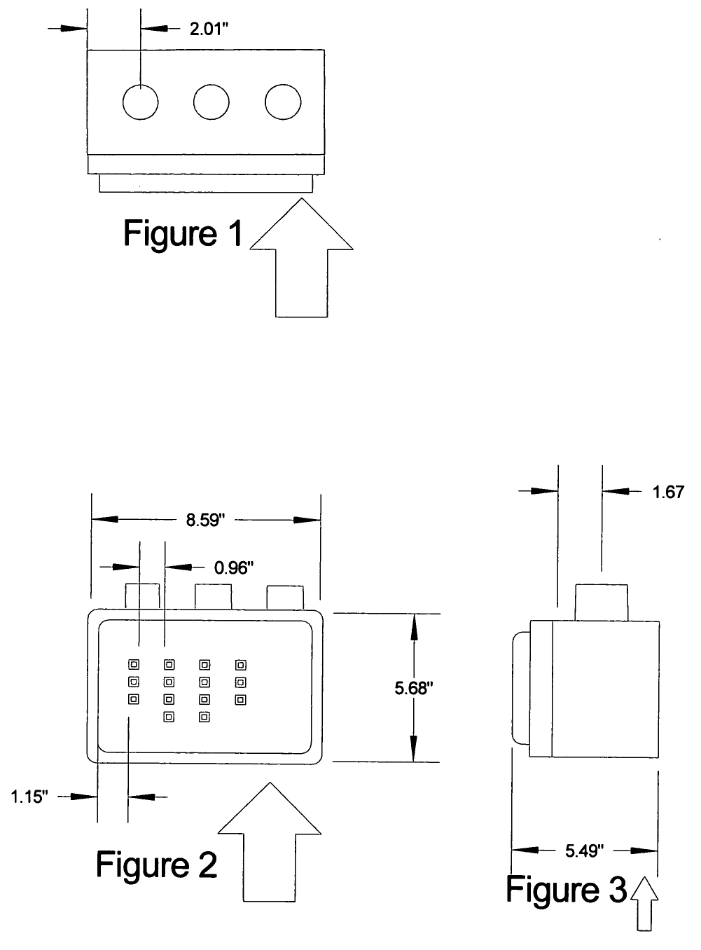

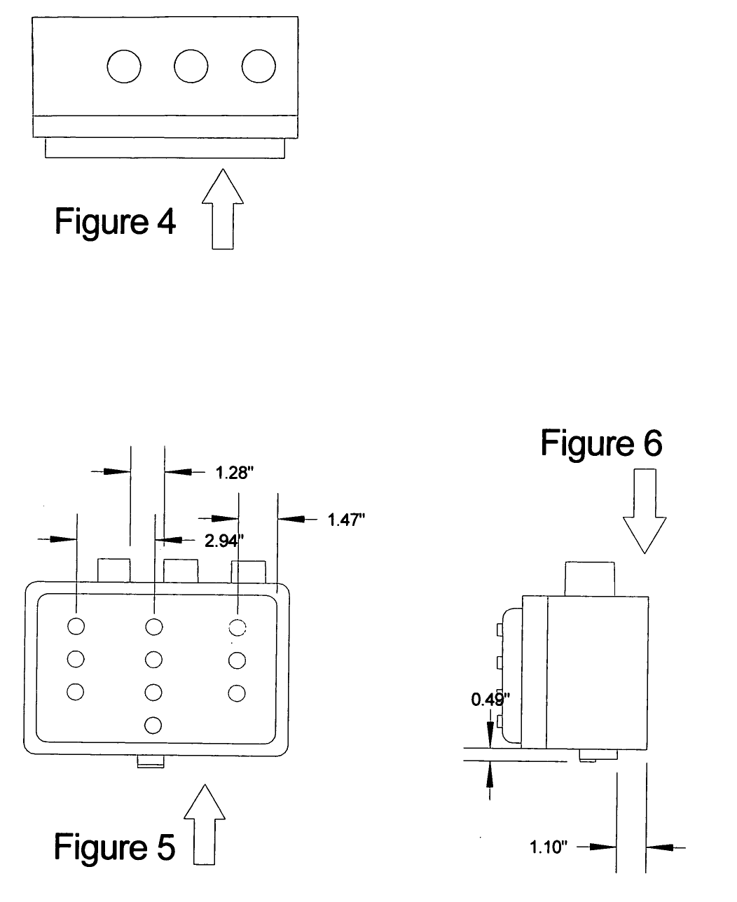

FIGS. 1, 2, 3, 4, 5, 6, 7, 8, and 9: Shows what a person would see if they were facing the professor side, student side, and placement of the PLC for the boiler trainer. The demotions on the figures where used in the production of the boiler trainer.

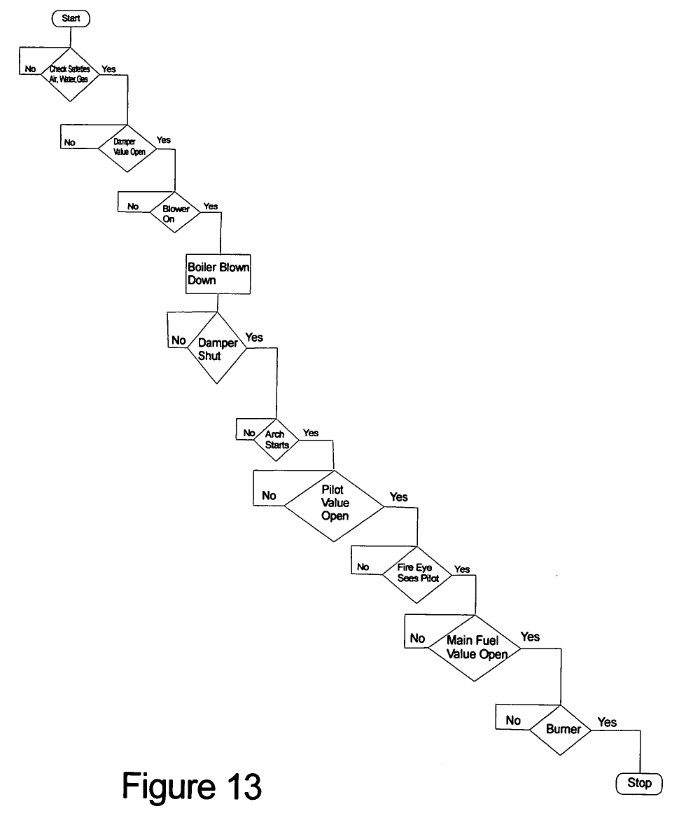

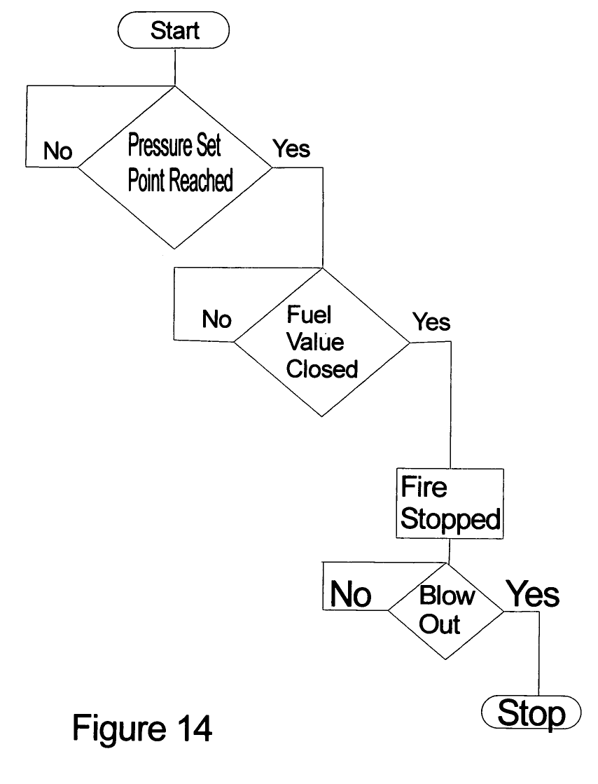

FIGS. 13 and 14: Flow charts for the basic start up and shut down of the boiler trainer. The Start Flow Chart has 10 steps and the Stop Flow Chart has 4 steps, which were used in deciding the number of inputs and outputs. For example on the Start Flow Chart where it says Damper Valve Open there are two inputs (Damper Valve Yes and Damper Valve No) each having a push button for the input, with one output (Damper Valve) having a light to show the damper valve is open (light on) and closed (light off).

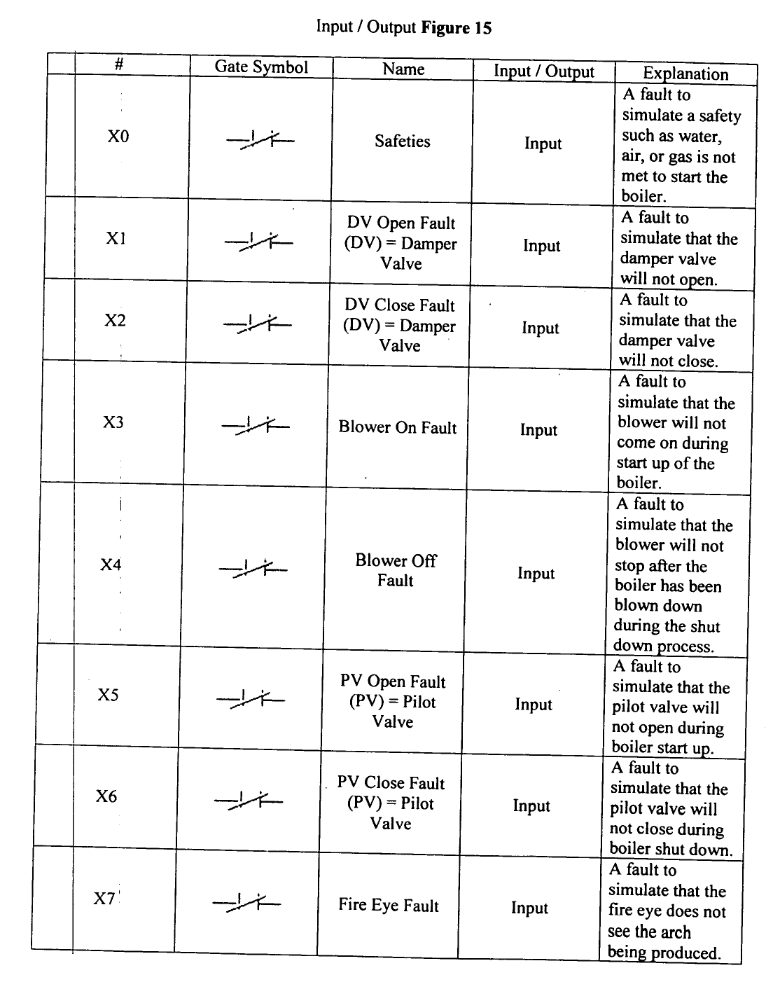

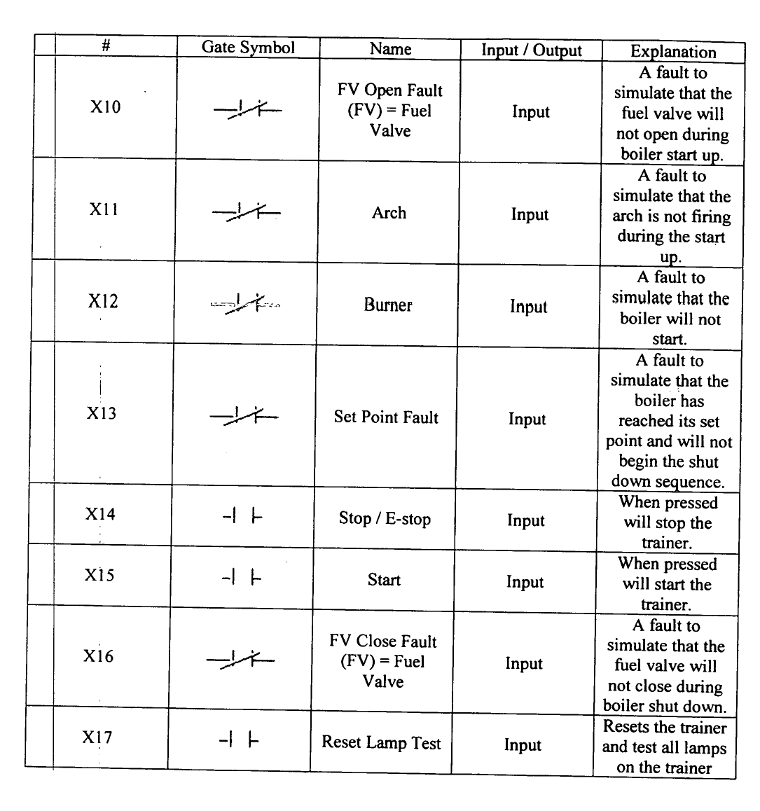

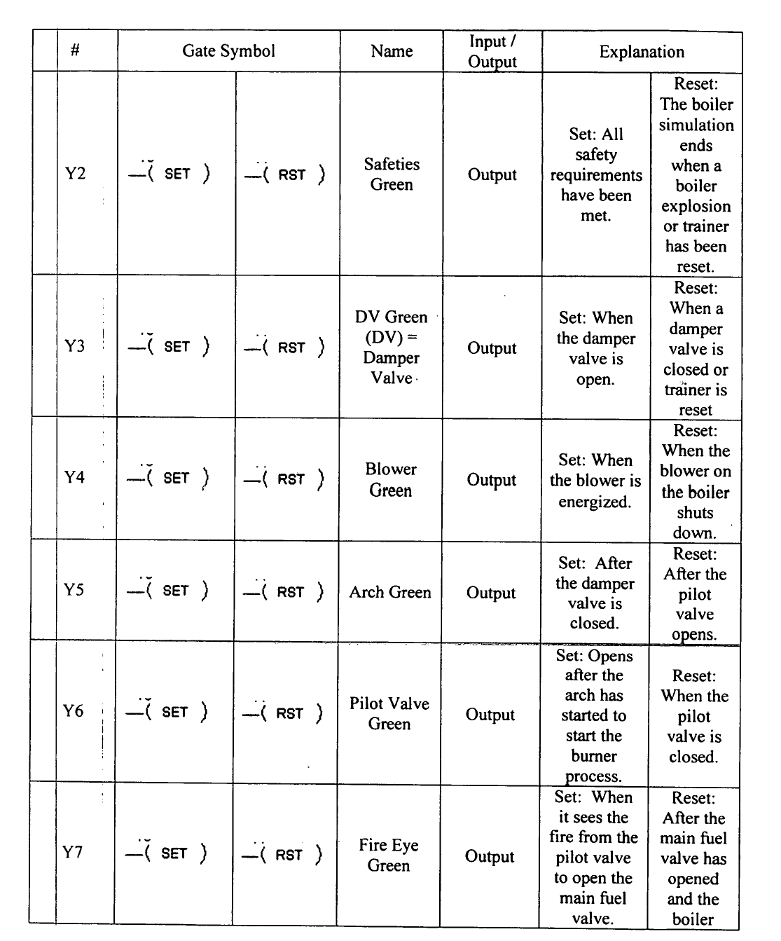

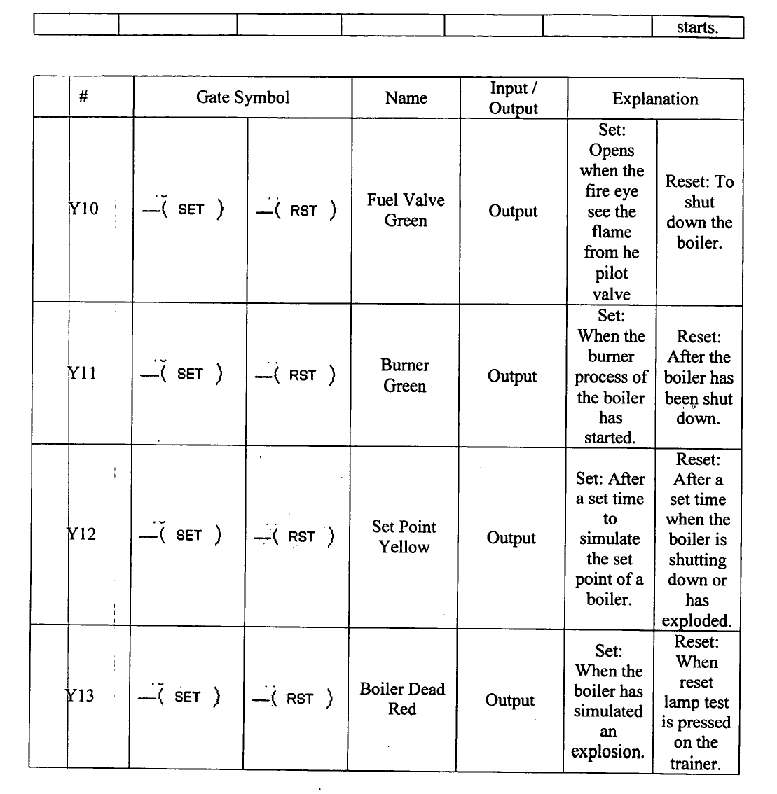

FIG. 15: Shows the Number, Gate symbol, Name, Type of Input/Output, and Explanation of the input/output. That was used in programming the PLC along with any abbreviation spelled out (DV=Damper Valve). X# . . . (X0 . . . ) are inputs X standing for input for the PLC and the number is the place for the input on the PLC. Y# . . . (Y0 . . . ) are outputs Y stranding for output for the PLC and the number is the place for the output on the PLC. There are sixteen inputs and 10 outputs to the Boiler Trainer X/Y8 and X/Y9 are skipped to the design.

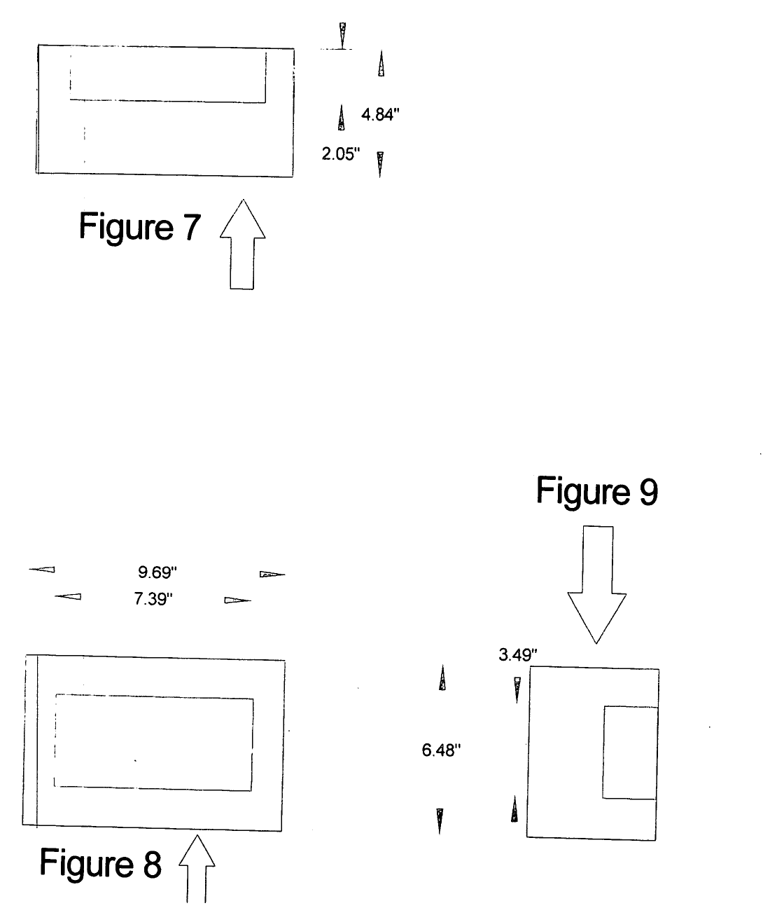

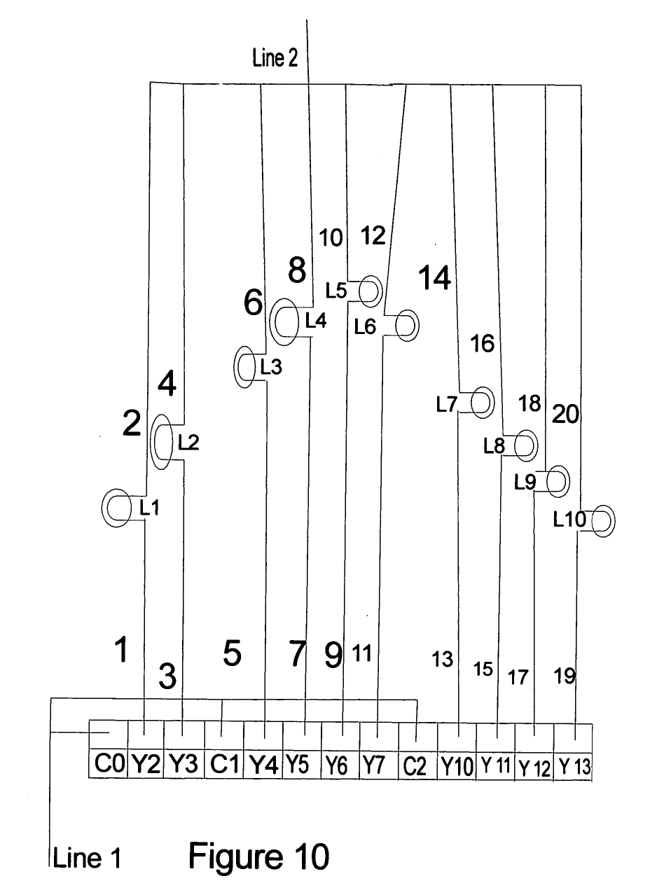

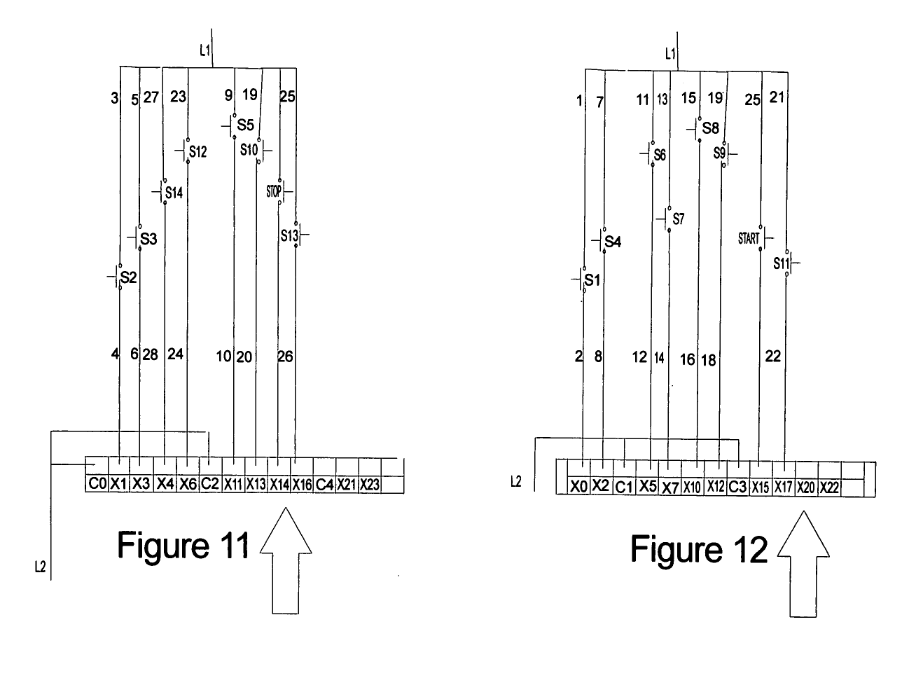

FIGS. 10, 11, and 12: The wiring diagrams that were used in the production of the Boiler Trainer. FIG. 6 (Wiring Diagram Lights Student Side) shows line one from power going to C0, C1, and C2 (C=common). C0 is the common for Y2 and Y3 power goes to L1 and L2 (L=light) and is returned top Line 2 of power. The same process is repeated for C1 and C2. FIG. 7 (Wiring Diagram Switches Professor Side) is also the same as in FIG. 6 but with the following difference. Power come from Line 1 to the switches then is returned to the commons.

### SUMMARY OF THE INVENTION

The first step in building the trainer was to join the enclosures together. Three 1-inch pieces of 3/4 inch PVC were cut, and three three-quarter inch holes were knocked out into the enclosures on the hinge side.

The next step was to drill holes in the cove of the trainer for the push buttons and lights. The push buttons are on the professor side, and the lights are on the student side. The covers of each enclosure had to be measured to ensure that the push buttons and lights could be evenly spaced. The cover measured 11 inches wide by 7.25 inches high. This makes each push button 1.835 inches by 0.4675 inches apart. The lights are 3.281 inches by 1.185 apart. For the push buttons, a 1/2-inch hole was drilled, and a 3/8-inch hole was drilled for the lights. Eighteen-gauge wire was used to connect the push buttons and lights. Each wire was labeled by using file folder labels, cut in half with the number printed onto the labels, using the envelope label tool in Microsoft Word.

Start/stop switch, power, and PLC were added to the trainer, thus completing the building of the trainer. Once the PLC was installed, the final wiring of the trainer began; this consisted of connecting the wires to the inputs, outputs, and power to the proper places (See wiring diagram and wiring sheet FIGS. 6 and 7) for more details. When the wiring was complete, the trainer was energized and a communication link was establish between the PLC and the PC using communication port 1 port, which would be used in the programming of the PLC. The software used was Direct Logic PLC programming and documentation application. This software set up the communication link and compiled this program for the PLC.

In order for the trainer to perform simulation of a start up, reach a set point, and to perform a shutdown, the following must be in order: All examine off/normally closed inputs must be in the off position, Stop/E-Stop must be set, and Start must be pressed. Lights on the trainer turning on and off signals to the trainee which parts of the simulation have been completed. During the simulation, if the sequences of lights stop or the red light on the trainer comes on, a fault would be indicated. Then the trainee would have to use troubleshooting skills to diagnose the problem and offer a solution to the problem. If the trainee were correct in the diagnoses, the professor would reset the trainer by clearing the fault to continue training. For more information, refer to ladder logic diagram and input/output chart.

The flow charts were used to determine the number of inputs and outputs the trainer would need. For example, during the start up of the boiler, the pilot valve must open and eventually close. From this example there can be two faults: pilot valve open fault and pilot valve close fault. Along with an indicator light for the pilot valve, when the light is on the pilot valve is open, and when the light is off the pilot valve is closed. Faults can be placed each time the boiler completes a step in the start up or shut down a fault can be placed.

The boiler trainer could be very cost effective for small industry. This type of training equipment would be very helpful because the people taking care of the boiler could receive the needed training in-house. The company would not have the high cost of sending the operator to an outside training school.

With this trainer, the operator would receive valuable experience in starting and operating the boiler, learning the value, and the need for the different safeties built in to the boiler. The operator would receive valuable troubleshooting experience being exposed to a high-pressure situation of a boiler not working properly in a production setting. Problems could be encountered and worked out before the livelihood of the entire plant is jeopardized by one piece of malfunctioning equipment.

This trainer could prove to be very useful in many applications.

### References Cited

Harris, Roy. “Effective Training Methods.” Bjj.orq: 18 Jun. 1999 <<http://www.bjj.org/articles/harris-training.html>>
Messmer, Max. “Cost Effective Training Programs.” National Public Accountant. April 2002: p 36-7
Bib Cochran. “Industrial Boiler Service Spare Training.” Training. http://www.bibcochran.com/training.htm
Brennan, Paul. “School Boiler Maintenance: Learn Safety.” Engineered Systems. March 2000. 50-2.
National Board Classic Series. “Recommendations for a Safe Boiler room.”<<http://www.nationalboard.org/classic/classic43a.html>>
Hugh, Jack. Automating Manufcturing System with PLC. 2003 <<http://claymore.engineer.gvsu.edu/˜jackh/books/plcs>>
Andrews, Jean. A+ Guide to Managing and Maintaining Your PC. 2003. p 402-403.

1. Increase safety in boiler operations

2. Remove the fear factor for first time operators

3. Increase communication between operators and upper management

4. Increase troubleshooting skills for operators

5. Improves overall safety in the facility

6. Make training cost effective

7. Improve to become more effective operation of the boiler will

8. Deceased problems with operators
